(19) United States
(12) Patent Application Publication
(10) Pub. No.: US 2024/0317328 A1
(43) Pub. Date: Sep. 26, 2024

(54) COMPOSITE PANEL AND METHOD FOR FORMING THE SAME

(71) Applicant: Wabash National, L.P., Lafayette, IN (US)

(72) Inventors: Leonard W. Baker, Lafayette, IN (US); Gustavo Sumcad, Westfield, IN (US); Brandon Davenport, Amboy, IN (US); Lynsey Liguori, Lafayette, IN (US); Michael Bodey, Lafayette, IN (US)

(21) Appl. No.: 18/674,721

(22) Filed: May 24, 2024

Related U.S. Application Data
(62) Division of application No. 17/118,164, filed on Dec. 10, 2020.
(60) Provisional application No. 62/947,926, filed on Dec. 13, 2019.

(51) Int. Cl. B62D 33/04; B29C 44/22; B32B 3/16; B32B 3/26; B32B 5/14; B32B 5/18

(52) U.S. Cl. CPC B62D 33/046; B29C 44/22; B32B 3/16; B32B 3/263; B32B 5/142; B32B 5/18; B32B 2266/025; B32B 2307/722; B32B 2607/00

(57) ABSTRACT

A method of forming a panel for use on a trailer is provided. The method may comprise extruding a panel member core of thermoplastic foam with a first region that includes a first density and a second region, adjacent the first region, that includes a second density less than the first density. The method can also include cutting the panel member core at a predetermined length. A sheet can be laminated to the panel member core, extending over the first and second regions.

### CROSS-REFERENCE TO RELATED APPLICATION

This application is a divisional of U.S. application Ser. No. 17/118,164, filed on Dec. 10, 2020, which claims priority under 35 U.S.C. § 119 to U.S. Provisional Patent Application No. 62/947,926, filed Dec. 13, 2019, the entire contents of which are incorporated herein by reference.

### BACKGROUND

Many storage containers, such as mobile storage containers for box or van-type trailers, include side walls and a roof assembly formed by multiple panel members coupled together. The panel members can be made from various types of materials in different configurations.

### SUMMARY

Some embodiments of the present disclosure can provide a method of forming a panel for use on a trailer. A panel member core of thermoplastic foam can be extruded. The thermoplastic foam can include a first region that includes a first density and a second region, adjacent the first region, that includes a second density less than the first density. The panel member core can be cut at a predetermined length. A sheet can be laminated to the panel member core, extending over the first and second regions.

According to one aspect of the present disclosure, a method of forming a panel member core with a length for a panel to be sued on a trailer is provided. A first region, a second region, a third region, a fourth region, and a fifth region can be extruded to extend along the length in parallel. The first, third, and fifth regions can be configured to have a greater density than the second and fourth regions. The extruded first, second, third, fourth, and fifth regions can be cut at the length.

### BRIEF DESCRIPTION OF THE DRAWINGS

The accompanying drawings, which are incorporated in and form a part of this specification, illustrate embodiments of the disclosed technology and, together with the description, serve to explain the principles of embodiments of the disclosed technology:

FIG. 1 is an isometric view of a trailer with panels;

FIG. 2 is a cross-sectional view of a panel shown on the trailer of FIG. 1;

FIG. 3 is an isometric view of a first example of a panel member core being formed having areas of various densities;

FIG. 4 is an isometric view of the panel member core formed from the process of FIG. 3;

FIGS. 5-5B are isometric views of a second example of a panel member core being formed having areas of various densities;

FIG. 6 is an isometric view of the panel member core formed from the process of FIG. 4; and

FIG. 7 is an isometric view of a third example of a panel member core being formed having areas of various densities.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

For the purposes of promoting an understanding of the principles of the invention, reference will now be made to illustrative embodiments shown in the attached drawings and specific language will be used to describe the same. Some of the discussion below describes a laminated panel member core that can be sandwiched between sheets formed from metal, plastic, reinforced plastic, or high modulus materials such as carbon fiber or aramid fiber. The context and particulars of this discussion are presented as examples only. For example, embodiments of the disclosed invention can be configured in various ways, including with other shapes and arrangements of elements. Similarly, while the concepts of this disclosure are described in relation to a truck trailer, it will be understood that they are equally applicable to other mobile or stationary storage enclosures or containers, as well as refrigerated and un-refrigerated trailers, storage containers, or truck bodies that include wall and/or roof panels joined together.

As used herein, directional terms including “top,” “bottom,” “side,” “horizontal,” “vertical,” and so on are used to indicate directional relationships with respect to an arbitrary reference frame (e.g., a reference frame of a particular figure or figures). These directional terms are used consistently relative to a particular embodiment. For example, a “top” feature of an embodiment is opposite a corresponding “bottom” feature, and a “horizontal” feature generally extends perpendicularly to a “vertical” feature. However, unless otherwise defined or limited, these directional terms are not intended to indicate an absolute reference frame for a particular assembly.

In conventional arrangements, panel members can be made from various types of materials in different configurations. For example, panel members can be made with hexagonal honeycomb cores that have a uniform internal structure and in which the axis of each honeycomb cell extends perpendicular to the length and width of the adjacent sheets. Cargo securement elements or fasteners must therefore be located in areas at or near the seams of adjacent panels where additional overlapping material is provided. Another example includes panel members comprising a core partially formed from a foamed thermoplastic and include higher density foam blocks inserted manually in locations in areas needing additional structural support. Although these conventional arrangements of panels can provide adequate structural strength and support for fasteners, mounting and fastening options for cargo securement elements and fasteners are limited and labor can be fairly intensive to manufacture the panel members.

Embodiments of the invention can address these or other issues. For example, in some embodiments, a panel member core can include areas of different densities. Some areas may be formed with higher density foam, respectively, for securing mounting elements or fasteners thereto, while other areas may be formed with lower density foam to reduce the overall weight of the panel member. As another example, other regions within the panel core can have densities between the densities of the higher and lower density regions. An example of the process for making a panel member core can include the extrusion and combination of streams of thermoplastic foam having the same or different densities. In some examples, the thermoplastic can be high density polyethylene (HDPE) or polypropylene (PP).

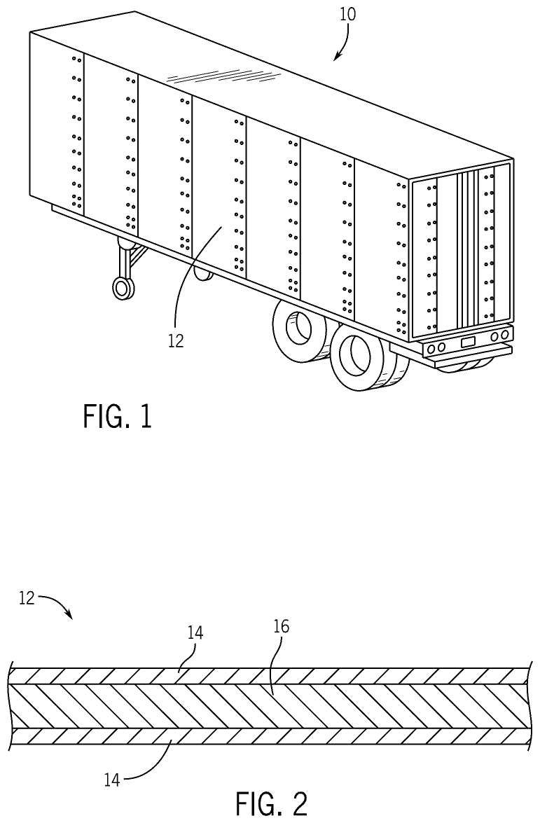

As shown in FIG. 1, a trailer 10 can comprise a plurality of interconnected panel members 12. As shown in FIG. 2, each of the panel members 12 can be formed by laminating sheets 14, or skins, to a panel member core 16.

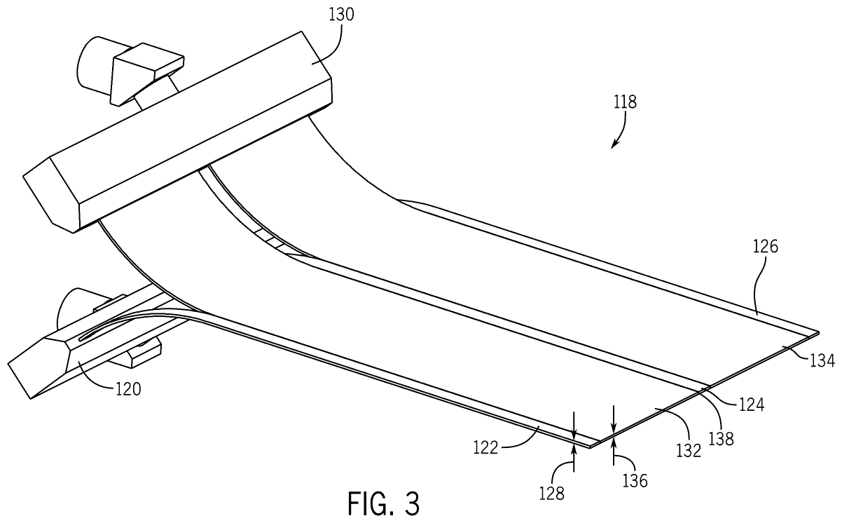

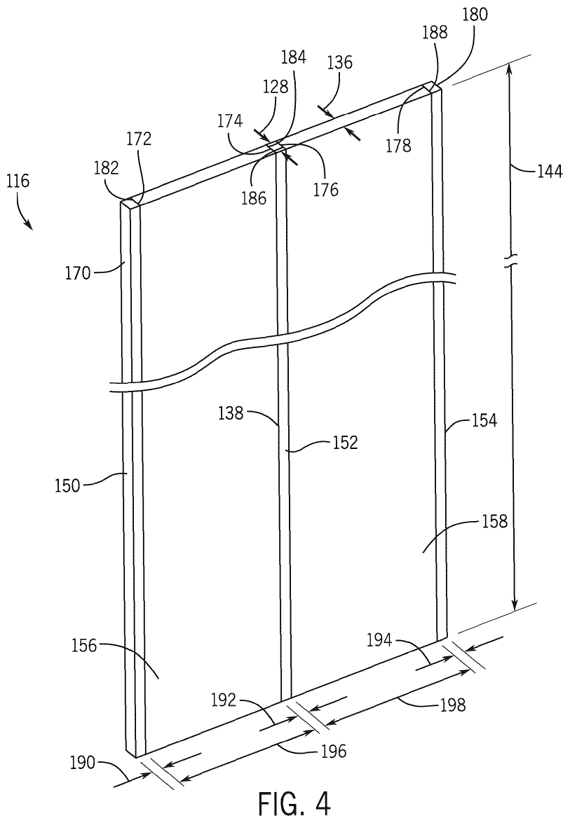

FIG. 3 illustrates a first example of a method of forming a panel member core 116 (FIG. 4) according to an embodiment of the invention. A first extruder 120 extrudes a first set of streams (a first stream 122, a third stream 124, and a fifth stream 126) of a thermoplastic foam all having a first thickness 128. A second extruder 130 extrudes a second set of streams (a second stream 132 and a fourth stream 134) of a thermoplastic foam all having a second thickness 136. The first thickness 128 is substantially equal to the second thickness 136. The first extruder 120 and the second extruder 130 can extrude at the same lineal feet per minute rate.

The first, third, and fifth streams 122, 124, 126 each have a first density, and the second and fourth streams 132, 134 each have a second density. In the example, the first density of the first, third, and fifth streams 122, 124, 126 extruded from the first extruder 120 can be greater than the second density of the second and fourth streams 132, 134 extruded from the second extruder 130. For example, the first density can be in the range of about 14 lb/ft³ to about 30 lb/ft³ and the second density can be in the range of about 1 lb/ft³ to about 13 lb/ft³. The streams 122, 124, 126, 132, 134 can be thermally welded together to form a single continuous panel member core stream 118, which can be cut to a predetermined dimension to form the panel member core 116 (FIG. 4). The first, third, and fifth streams 122, 124, 126 define a first, third, and fifth segment 150, 152, 154, respectively, each having a set of opposing lateral faces, including a first lateral face and a second lateral face, defined by a length and thickness of the segment, and the second and fourth streams 132, 134 define a second and fourth segment 156, 158, respectively, each having a set of opposing lateral faces, including a first lateral face and a second lateral face, defined by a length and thickness of the segment, in the panel member core 116. The segments 150, 152, 154, 156, 158 extend parallel with each other along the length 144 of the panel member core 116, with adjacent lateral faces interfaced with each other. For example, a first lateral face 170 of the first segment 150 is exposed along a side of the panel member core 116, a second lateral face 172 of the first segment 150 interfaces with a first lateral face 182 of the second segment 156, a second lateral face 184 of the second segment 156 interfaces with a first lateral face 174 of the third segment 152, a second lateral face 176 of the third segment 152 interfaces with a first lateral face 186 of the fourth segment 158, a second lateral face 188 of the fourth segment 158 interfaces with a first lateral face 178 of the fifth segment 154, and a second lateral face 180 of the fifth segment 154 is exposed along a side of the panel member core 116 opposite the first lateral face 170 of the first segment 150. When installed on the trailer 10, each of the segments 150, 152, 154, 156, 158 extends from the top of the trailer 10 to the bottom.

The first, third, and fifth segments 150, 152, 154 are shown with respective widths 190, 192, 194 that are smaller than the widths 196, 198 of the second and fourth segments 156, 158, respectively. However, other configurations with segments of different widths are contemplated, including the inverse of the panel member core 116, and the figures should not be viewed as limiting.

In other embodiments, other configurations are possible. For example, more or fewer alternating extrusion streams of different or similar densities can be combined to form a panel member core as determined by the predetermined structural and weight requirements. For example, in some embodiments, the first, third, and fifth streams 122, 124, 126 can each have a different density. In some embodiments, two of the first, third, and fifth streams 122, 124, 126 can have the same density and the other of the first, third, and fifth streams 122, 124, 126 can have a lesser or a greater density. In some other embodiments, the densities of the second and fourth streams 132, 134 can be different. In some embodiments, at least two of the densities of the first, second, third, fourth, and fifth streams 122, 132, 124, 134, 126 can be the same.

A weld zone 138 can be formed between any two adjacent, thermally welded extrusion streams, for example, between the second stream 132 and the third stream 124 shown in FIG. 3. The weld zone 138 can be formed during the thermal welding process to create a non-porous solid wall of homogenous plastic extending the length 144 and thickness 128, 136 of the panel member core stream 118 between the two extrusion streams 132, 124. The weld zone 138 can increase the compressive strength of the panel member core 116, making it more resistant to compressive loads. The compressive strength of the panel member core 116 can be further aided by the foam of the streams 132, 124 provided on either side of the weld zone 138 further resisting deflection.

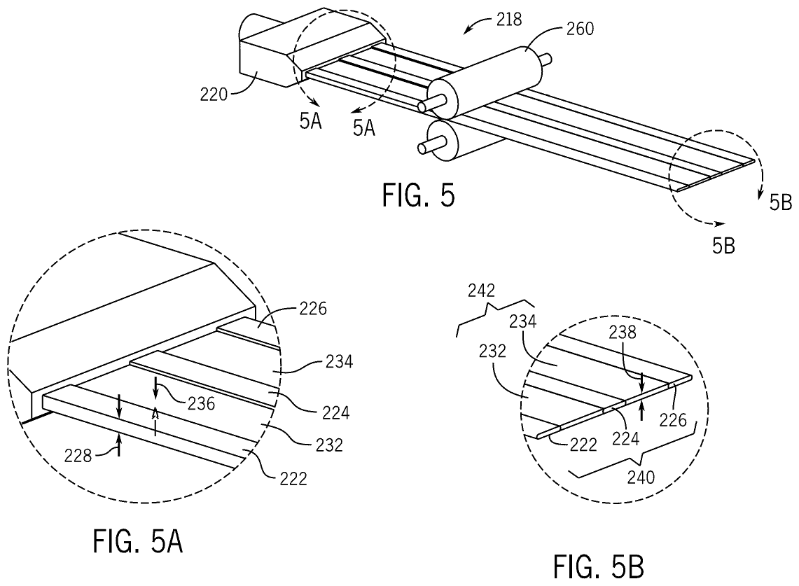

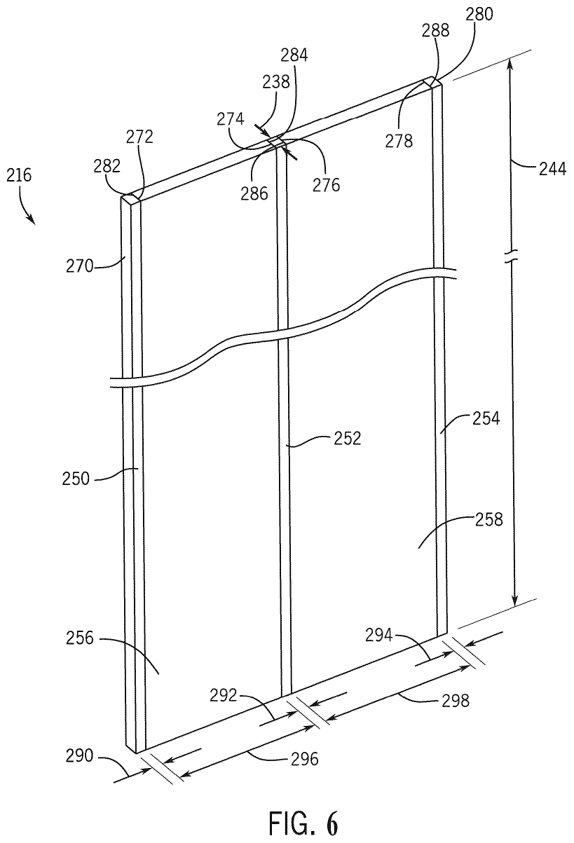

FIGS. 5, 5A, and 5B illustrate another example of a method of forming a panel member core 216 (FIG. 6) according to another embodiment of the invention. An extruder 220 extrudes a continuous panel member core extrusion 42 having a first set of regions 240 (a first region 222, a third region 224, and a fifth region 226) and a second set of regions 242 (a second region 232 and a fourth region 234). The continuous panel member core extrusion 218 can have a density in a range from about 1 lb/ft³ to about 25 lb/ft³. The first, third, and fifth regions 222, 224, 226 are extruded at a first thickness 228 and the second and fourth 232, 234 are extruded at a second thickness 236 (FIG. 4A). The first thickness 228 is greater than the second thickness 236. For example, the first thickness can be about 1 inch and the second thickness can be about ½ inch. In other embodiments, other configurations are possible. For example, more or fewer regions of different or similar thicknesses can be combined to form a panel member core as determined by the predetermined structural and weight requirements. For example, in some embodiments, the thicknesses of the first, third, and fifth regions 222, 224, 226 can each have a different thickness. In some embodiments, two of the first, third, and fifth regions 222, 224, 226 can have the same thickness and the other of the first, third, and fifth regions 222, 224, 226 can have a smaller or a greater thickness. In some other embodiments, the thicknesses of the second and fourth regions 232, 234 can be different. In some embodiments, at least two of the thicknesses of the first, second, third, fourth, and fifth streams 222, 232, 224, 234, 226 can be the same.

At least the first set of regions 240 of the panel member core stream 218 can be compressed to a third thickness 238 (FIG. 5B). The third thickness 238 can be equal to the second thickness 236 to form a panel member core stream 218 of uniform thickness. It is also contemplated that the second set of regions 242 can also be compressed at the same time as the first set of regions 240 to provide a uniform thickness of the panel member core stream 218. Continuing with the example of the first and second thicknesses 228, 236 above, the third thickness 238 can be in the range of about 7/16 inch to about ½ inch. In FIG. 5, for example, a set of rollers 260 are shown performing the compression of the panel member core stream 218.

The compression of the first, third, and fifth regions 222, 224, 226 and the second and fourth regions 232, 234 to the third thickness 238 increases the density of the first, third, and fifth regions 222, 224, 226 relative to the second and fourth regions 232, 234. In the example provided, the density of the first, third, and fifth regions 222, 224, 226 is approximately double the density of the second and fourth regions 232, 234 because the first, third, and fifth regions 222, 224, 226 were about twice the thickness of the second and fourth regions 232, 234 in the panel member core extrusion 218 and were compressed to the same thickness of the second and fourth regions 232, 234 in the panel member core stream 218.

After compression, the first, third, and fifth regions 222, 224, 226 can have a first density and the second and fourth regions 232, 234 can have a second density. The first density can be in the range of about 14 lb/ft³ to about 30 lb/ft³ and the second density can be in the range of about 1 lb/ft³ to about 13 lb/ft³. The panel member core stream can be cut to a predetermined dimension to form the panel member core 216 (FIG. 6).

Similar to the example method of forming the panel member core 116 described above, the panel member core stream 218 can be cut to a predetermined dimension to form the panel member core 216 (FIG. 6). The first, third, and fifth regions 222, 224, 226 can define first, third, and fifth segments 250, 252, 254, respectively, each having a set of opposing lateral faces, including a first lateral face and a second lateral face, defined by a length and thickness of the segment, and the second and fourth regions 232, 234 can define second and fourth segments 256, 258, respectively, each having a set of opposing lateral faces, including a first lateral face and a second lateral face, defined by a length and thickness of the segment, in the panel member core 216. The segments 250, 252, 254, 256, 258 extend parallel with each other along the length 244 of the panel member core 216, with adjacent lateral faces interfaced with each other. For example, a first lateral face 270 of the first segment 250 is exposed along a side of the panel member core 216, a second lateral face 272 of the first segment 250 interfaces with a first lateral face 282 of the second segment 256, a second lateral face 284 of the second segment 256 interfaces with a first lateral face 274 of the third segment 252, a second lateral face 276 of the third segment 252 interfaces with a first lateral face 286 of the fourth segment 258, a second lateral face 288 of the fourth segment 258 interfaces with a first lateral face 278 of the fifth segment 254, and a second lateral face 280 of the fifth segment 254 is exposed along a side of the panel member core 216 opposite the first lateral face 270 of the first segment 250. When installed on the trailer 10, each of the segments 250, 252, 254, 256, 258 extends from the top of the trailer 10 to the bottom.

The first, third, and fifth segments 250, 252, 254 are shown with respective widths 290, 292, 294, that are smaller than the widths 296, 298 of the second and fourth segments 256, 258, respectively. However, other configurations with segments of different widths are contemplated, including the inverse of the panel member core 216, and the figures should not be viewed as limiting.

In other embodiments, other configurations are possible. For example, more or fewer alternating extrusion stream regions of different thicknesses and different or similar densities can be formed to provide a panel member core 216 as determined by the predetermined structural and weight requirements.

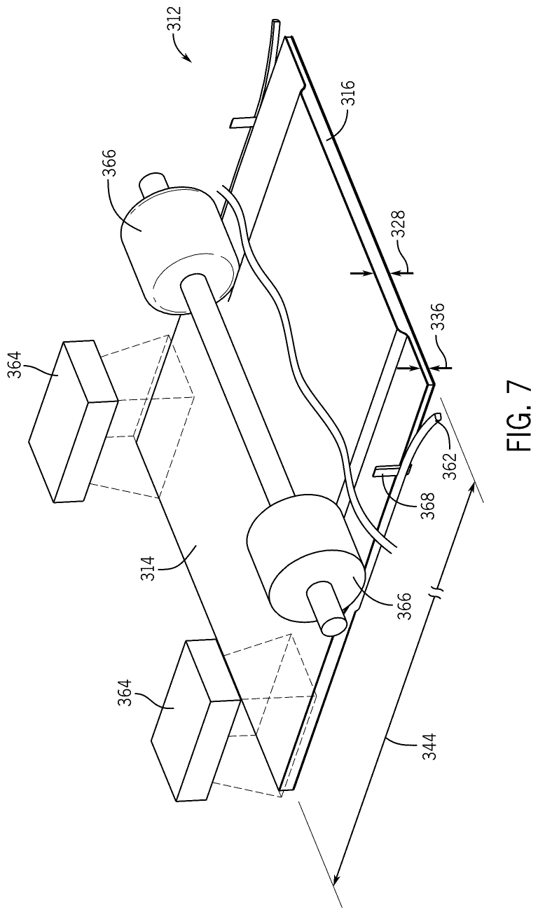

FIG. 7 illustrates an example of a method of forming a panel member 312 according to an embodiment of the invention. An extruder forms a panel member core 316 having a first thickness 328 and a first density, both of which are uniform throughout the panel member core 316. A sheet 314 is laminated to one or both sides of the panel member core 316. The example in FIG. 7 shows a sheet 314 laminated to both sides of the panel member core 316. The combination of the sheets 314 and the panel member core 316 is then processed, wherein at least one predetermined area along the length 344 of the panel member 312 is designated to have a higher density. The predetermined area is heated locally with heaters 364 and compressed to a second thickness 336, which is less than the first thickness 328, to from the panel member 312, wherein the compressed area has a greater density than the non-compressed area. As shown, the compression may be performed by rollers 366 along the sides of the panel member 312. Excess material 362 may be trimmed with a trimming apparatus 368 as needed. Similar density values as provided above with respect to the other methods of forming a panel member core may be achieved in the regions having the first thickness 328 and the second thickness 336. It should be noted that in some embodiments additional or fewer areas of compression are contemplated. For example, one of the rollers 366 can be removed or at least one additional roller can be added. In some embodiments, a panel member can have another area with a thickness different than the first and second thicknesses 328, 336. For example, the rollers 366 can be configured to compress the panel member to different thicknesses (e.g., by using rollers of different diameters). In another example, another roller configured to compress the panel member to a third thickness can be added.

Thus, the above-described methods for forming panel member cores can form panel member cores having different strength and weight characteristics. Areas within the panel member cores having a greater density can provide additional strength to reduce fastener tear out where hardware is bonded thereto or where panels are joined together. Areas within the panel member cores having a lower density, respectively, can reduce overall panel weight in areas in which additional strength is not required.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. Furthermore, it will be understood that the embodiments discussed above are presented as examples only, and that other embodiments are possible. Moreover, it is intended and will be appreciated that embodiments may be variously combined or separated without parting from the invention. For example, it will be appreciated that all preferred features described herein are applicable to all aspects of the invention described herein.

The description herein of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A method of forming a panel for use on a trailer, the method comprising:
extruding a panel member core of thermoplastic foam with a first region having a first density and a second region, adjacent the first region, having a second density less than the first density;
cutting the panel member core at a predetermined length; and
laminating a sheet to the panel member core, extending over the first and second regions.

2. The method of claim 1, further comprising a third region adjacent the second region, opposite the first region, the third region having the first density; and
wherein the sheet extends over the first, second, and third regions.

3. The method of claim 1, wherein the first region of thermoplastic is extruded from a first extruder and the second region of thermoplastic is extruded from a second extruder, the method further comprising thermally welding the first region with the second region.

4. The method of claim 1, wherein the first region of thermoplastic is extruded with a first thickness and the second region of thermoplastic is extruded with a second thickness, wherein the first thickness is greater than the second thickness, the method further comprising compressing at least the first region to form a panel member core with a uniform thickness.

5. The method of claim 1, wherein the method further comprises:
heating the first region after the sheet is laminated to the panel member core; and
compressing the heated first region to increase the density.

6. A method of forming a panel member core with a length for a panel to be used on a trailer, the method comprising:
extruding a first region, a second region, a third region, a fourth region, and a fifth region to extend along the length in parallel;
the first, third, and fifth regions being configured to have a greater density than the second and fourth regions; and
cutting the extruded first, second, third, fourth, and fifth regions at the length.

7. The method of claim 6, wherein the method further comprises thermally welding the first, second, and third regions the fourth and fifth regions.

8. The method of claim 6, wherein the method further comprises compressing the first, second, and third regions.
